(19) United States
(12) Patent Application Publication
(10) Pub. No.: US 2026/0009817 A1
(43) Pub. Date: Jan. 8, 2026

(54) MEASURING ARRANGEMENT WITH A CONNECTING ELEMENT

(71) Applicant: Drägerwerk AG & Co. KGaA, Lübeck (DE)

(72) Inventors: Regina BEST-TIMMANN, Lübeck (DE); Judith LÖSER, Lübeck (DE); Ibrahim DAG, Lübeck (DE)

(21) Appl. No.: 19/254,194

(22) Filed: Jun. 30, 2025

(30) Foreign Application Priority Data
Jul. 4, 2024 (DE) 10 2024 118 974.6

(51) Int. Cl. G01P 5/12; G01P 1/00

(52) U.S. Cl. CPC G01P 5/12; G01P 1/00

(57) ABSTRACT

A measuring arrangement (490) includes a measuring bridge (400) and an electrical connection element (49) for a flow sensor. The flow sensor is configured to measure the flow rate according to the measuring principle of hot-wire anemometry. A number of electrical contact arrangements (45, 46, 47), arranged on a support element (200) with a common equipotential surface (22), are used for electrical contacting of carrier elements (44) and resistance sensors C1 (55), W2 (66), W1 (77).

### CROSS REFERENCE TO RELATED APPLICATIONS

This application claims the benefit of priority under 35 U.S.C. § 119 of German Application 10 2024 118 974.6, filed Jul. 4, 2024, the entire contents of which are incorporated herein by reference.

### TECHNICAL FIELD

The present invention relates to an electrical connection element for a measuring arrangement with a flow sensor.

### BACKGROUND

The function of the flow sensor is based on thermal anemometry, in particular in the form of thermal anemometry with a number of hot wires arranged on support elements, so-called hot-wire anemometry.

DE 25 05 669 C3 describes a sensor that is used specifically in medical technology to compensate for the influence of the temperature of the measured gas on the measurement signal of the hot wire when measuring the respiratory gas volume flow in a Wheatstone bridge circuit.

Measuring the respiratory gas volume flow is a component of practically all modern ventilators and anesthesia machines. In hot-wire anemometry, a thin, heated wire, the so-called hot wire, is cooled by the flow of measured or respiratory gas. The change in resistance of the hot wire is a measure of the passing gas volume flow.

A circuit arrangement with two measuring bridges is known from DE 101 33 120 A1, which is able to determine both a flow rate and its direction of flow on the basis of a number of three resistance sensors configured as platinum wires in a flow chamber formed as a measuring cuvette.

Two of the platinum wires are used for flow measurement, the third resistance sensor is used for temperature compensation, as described in DE 25 05 669 C3.

The circuit arrangement of DE 101 33 120 A 1 enables temperature compensation with only one resistance sensor in relation to the gas temperatures of the gases present in the flow chamber for both resistance sensors.

To determine the flow direction, a shadow body is provided in the flow chamber so that one of the three platinum wires in one flow direction experiences a different flow in its shadow than in the opposite flow direction.

The disadvantage of this is that the shadow body contributes to a significant pressure drop in the measuring cuvette, especially with larger flow rates.

It is therefore advantageous to determine a flow direction by evaluating a heat transfer between two resistance sensors of the flow sensor without the need for a shadow body.

In order to enable an evaluation of the heat transfer with good reproducibility and sufficient accuracy, it is essential that the electrical signals between the resistance sensors in the flow sensor and in the electronic components take place with little interference, distortion or loss.

### SUMMARY

Based on the state of the art, it is an object of the present invention to provide a configuration of an electrical connection of a flow sensor with a measuring bridge, which enables an error-minimized evaluation of a determination of a flow rate and a determination of a flow direction.

The problem is solved by a measuring arrangement with a measuring bridge and with an electrical connection element for a flow sensor, the electrical connection element being configured to form a plurality of electrical plug connections between the measuring bridge and a plurality of supporting elements of at least two resistance sensors of the flow sensor. The flow sensor is configured for hot-wire anemometry flow rate measurement. The electrical connection element comprises a plurality of electrical contact arrangements arranged on a carrier element. The plurality of electrical contact arrangements comprise at least four electrical contact arrangements. The carrier element comprises at least one common equipotential surface which electrically conductively connects at least two contact arrangements, of the plurality of electrical contact arrangements, to one another.

The problem is further solved by a measuring arrangement with a measuring bridge and with an electrical connection element for a flow sensor, the electrical connection element being configured to form electrical plug connections between the measuring bridge and at least six support elements of three resistance sensors of the flow sensor. The flow sensor is configured for hot-wire anemometry flow rate measurement. The electrical connection element comprises a plurality of electrical contact arrangements arranged on a carrier element. The plurality of electrical contact arrangements comprise at least six electrical contact arrangements. The carrier element comprises at least one common, electrically conductively connects at least three contact arrangements, of the plurality of contact arrangements, to one another.

Advantageous embodiments of the invention result from this disclosure, including the claims, and are explained in more detail in the following description with partial reference to the figures.

The embodiments described each represent special embodiments both individually and in combination or combinations with one another. All and any further embodiments resulting from the combination or combinations of several embodiments and their advantages are nevertheless also covered by the inventive concept, even if not all possible combinations of embodiments are described in detail.

According to a first aspect of the invention, the problem is solved by a measuring arrangement with at least four support elements. At least two resistance sensors are arranged on the at least four support elements. The measuring arrangement according to the invention has a measuring bridge and an electrical connection element. The electrical connection element is used to form a plurality of electrical plug connections between the measuring bridge and a flow sensor. The flow sensor is configured with at least two resistance sensors for flow measurement according to the principle of hot-wire anemometry.

The measuring arrangement according to the first aspect of the invention has at least four support elements on which the at least two resistance sensors of the flow sensor are arranged.

According to a further aspect of the invention, the problem is solved by a measuring arrangement with at least six support elements. At least three resistance sensors are arranged on the at least six support elements

This measuring arrangement according to the further aspect of the invention has, like the measuring arrangement according to the first inventive aspect, a measuring bridge and an electrical connection element. The electrical connection element serves to form a plurality of electrical plug connections between the measuring bridge and a flow sensor. The flow sensor is configured with at least three resistance sensors for flow measurement according to the principle of hot-wire anemometry.

The aspects which are solved in the same way in the solutions of the first and the further inventive aspect are now explained in more detail in a common context in a common description. The common advantages are mentioned and where appropriate differences between the first and the further inventive aspect are indicated.

The measuring arrangement with the measuring bridge is configured according to the principle of a Wheatstone bridge, often also referred to as a Wheatstone resistance measuring bridge. A Wheatstone bridge is an electrical circuit that is used to accurately measure the values of unknown resistors. It usually consists of four resistors that form such a bridge circuit.

One of the resistors is often a temperature-sensitive resistor, such as a very precise platinum resistor, so that even the smallest temperature changes on the platinum resistor can be measured very finely and accurately and evaluated using the bridge circuit. In thermal anemometry, a measuring bridge is combined with at least one hot wire as a resistance sensor.

The hot wire sensor is usually configured as a very fine platinum wire, which is heated to a temperature above the ambient temperature during operation of the bridge circuit. If the hot wire is now exposed to a flow, heat is transferred from the hot wire to the flow. This heat transfer results in a change in resistance of the hot wire, which acts as a measuring effect in the bridge circuit and, depending on the operating mode of the measuring bridge, can be evaluated in constant current anemometry (CCA) mode or constant temperature anemometry (CTA) mode in order to determine a flow velocity or a flow rate in a flow channel of the flow sensor.

The support elements are elements of the flow sensor and protrude with the resistance sensors into the flow channel of the flow sensor on the sensor side.

These support elements can therefore also be referred to as sensor-side support elements.

The support elements are contacted by the electrical connection element. In addition to electrical contacting, this contacting by the electrical connection element can also include mechanical coupling of the flow sensor to the measuring bridge.

The arrangement of the measuring sensors, preferably configured as platinum wires, for example, can be configured as a clamping arrangement on the support elements with alignment in the flow channel of the flow sensor. The resistance sensors can preferably be attached to or on the support elements, for example by means of a welded or soldered connection.

The electrical connection element has a carrier element. The carrier element has a common equipotential surface (common equipotential body/common equipotential area).

According to the first inventive aspect, the electrical connection element has a number of at least four electrical contact arrangements (contacts) arranged on the carrier element.

According to the first inventive aspect, this equipotential surface electrically conductively connects a number of at least two contact arrangements of the four contact arrangements on the carrier element to one another.

According to the further inventive aspect, the electrical connection element has a number of at least six electrical contact arrangements arranged on the carrier element.

This equipotential surface according to the further inventive aspect connects a number of at least three contact arrangements of the six contact arrangements on the carrier element in an electrically conductive manner.

The electrical contact arrangements enable direct electrical contacting of the support elements or electrical contacting of the support elements with an optional cable connection, such as a cable supply line. By means of this—preferably and in particular flexibly configured—cable connection, the electrical connection element and thus also the flow sensor can be arranged at a distance from the measuring bridge, for example close to the head area or close to the mouth/nose area of a patient.

In such an embodiment, the measuring arrangement with the electrical connection element and the electrical contact arrangements, the line connections and the measuring bridge can enable near-patient flow measurement, for example on the so-called Y-piece.

The measuring bridge can be configured as part of a medical measuring device, part of a ventilator or part of an anesthesia device.

The equipotential surface as part of the carrier element in the electrical connection element creates a very low-resistance connection and thus an equalization between the electrical potentials of the electrical contacts of the support elements electrically connected to each other by the equipotential surface.

By combining several supporting elements in the equipotential surface, the electrical potentials of these supporting elements are connected to each other with low resistance to form a common electrical potential.

This very low impedance coupling by means of the equipotential surface offers the advantage, that the effects of transition resistances, which can occur differently, variably and randomly at the contact arrangements during operation of the measuring arrangement due to plugging and unplugging—in particular multiple plugging of the support elements to the contact arrangements—can be reduced with regard to the accuracy of the flow measurement.

In the measuring arrangement, the equipotential surface enables the bridge supply energy to be fed from the measuring bridge to the resistance sensors on the electrical connection element without potential differences between the electrically coupled support elements of the flow sensor.

A further advantage of the arrangement of the equipotential surface in the electrical connection element or as a component of the electrical connection element is that, in comparison, if all support elements were individually contacted, a separate continuation of one and/or two wires (cores) in a cable connection to the measuring bridge would result in a multi-wire (multi-core) cable with a large number of wires.

The following is an example using the measuring arrangement with six support elements as the number of support elements:

In the case of a single contact with two wires each with two contact arrangements per support element, a cable for connecting the connecting element would result in twelve wires as the number of wires.

When combining contact arrangements of three support elements in the equipotential surface, two wires are required, and with two wires with two contact arrangements for every three support elements, a total of six wires remain resulting in a total of eight wires for the six support elements.

A direct advantage of this is that such a cable with eight wires can be made up to be around fifty percent smaller in diameter. As a result, such a cable can be lighter, more flexible and less expensive and is easier for the user to handle.

In a particularly preferred embodiment, the electrical connection element has contact arrangements with double contact elements. The electrical contact arrangements are configured with a number of two contact arrangements as double contact elements and are arranged on the carrier element. Each of the double contact elements is configured to accommodate the same support element of the corresponding resistance sensor.

In this way, the support elements are each electrically connected to the measuring bridge by two electrical contacts. At least from the support elements that are not connected to each other by means of the equipotential surface, separately routed line connections—for example as wires or strands of a connecting cable—can be routed to the measuring bridge by means of the double contact elements.

The separately routed cable connections make it possible to separate current-carrying, i.e. energy-supplying, cable paths from measuring lines along the entire connection from the support elements to the measuring bridge, so that there are no voltage drops of a magnitude on the measuring lines that could adversely affect the operation of the measuring bridge for flow measurement in terms of accuracy.

The combination of the double contact elements and the equipotential surface has the cumulative advantage that measurement signals can be routed from the flow sensor to the measuring bridge without interference from equalizing currents between the sensors in the connecting element and the cable connection.

In a particularly preferred embodiment of the measuring arrangement, the double contact elements can be configured by means of the carrier element for connection to line connections of a connecting cable.

The connecting cable can be configured with the cable connections for electrical contact with the measuring bridge.

In a particularly preferred embodiment of the measuring arrangement, an arrangement of an electrical test contact element and a test contact on the sensor side.

The electrical test contact element can be arranged on the electrical connection element or on the carrier element and is configured to form an electrical connection between a measuring bridge and the sensor-side test contact.

The electrical test contact element is configured in relation to the sensor-side test contact and the support elements in such a way that when the flow sensor is connected to the electrical connection element, an electrically lagging (delayed) connection is created between the sensor-side test contact and the electrical test contact element compared to the electrical connection between all double contact elements and the associated support elements.

This design of a contact configuration comprising a test contact element on the connecting element and a test contact on the sensor side ensures that during a plugging process (mating process), complete plugging and connection of the support elements to the double contact elements with the formation of a stable electrical, i.e. wobble-free, contact between all support elements and the double contact elements can be detected, since the electrical connection between the test contact element and the test contact on the sensor side is only established when the support elements have been fully plugged and connected to the double contact elements. By interrogating (querying) this electrical connection between the test contact element and the test contact on the sensor side by means of a continuity test, it is possible to check whether or that the plugging process with the formation of an electrically conductive connection between the test contact element and the test contact on the sensor side has been carried out successfully.

In a particularly preferred embodiment of the measuring arrangement, a control unit can be provided which, when the flow sensor is connected to the electrical connection element, initiates activation of an electrical power supply or an electrical power supply to the measuring bridge in the event of a contact connection between the sensor-side test contact and the electrical test contact element. This advantageously results in the safety-specific aspect for the operation of the measuring arrangement explained below. The control unit can be suitably configured to carry out an electrical continuity test or resistance measurement of the connection between the test contact element and the sensor-side test contact in order to check whether or that the mating process between the test contact element and the sensor-side test contact has been carried out successfully.

If the plugging process between the test contact element and the sensor-side test contact has been successfully completed and a stable electrical connection has been established between the support elements and the double contact elements, the control unit initiates activation of the electrical power supply or the electrical power supply of the measuring bridge.

The control unit thus causes—for example by means of an electronic (FET, transistor) or a mechanical (relay) switching element—a connection of the electrical power supply to the combination of measuring bridge, cable connection and the flow sensor with the support elements and the resistance sensors.

In a particularly preferred embodiment of the measuring arrangement, the control unit can be configured for an electrical resistance measurement. The control unit can initiate or perform a resistance measurement on at least one of the resistance sensors C1, W2, W1 of the flow sensor in order to determine and provide a data set of current sensor-specific values.

The control unit is configured to carry out an electrical resistance measurement of the resistance sensors arranged on the support elements in addition and/or as an alternative to the electrical continuity test between the test contact element and the test contact on the sensor side.

The control unit can also be configured to detect voltage signals of the measuring bridge, such as voltage signals that can be measured at a precision measuring resistor or at several precision measuring resistors, and a current flow in the measuring bridge through the precision measuring resistor or the precision measuring resistors and the resistance sensors arranged in series with the precision resistor or several precision resistors, for example platinum hot wires, and to determine a current flow state at a resistance sensor or current flow states at several resistance sensors based on this. Based on the currently determined flow state or the currently determined flow states, the control unit can implement a flow measurement function or a flow rate measurement and thus, together with the support elements, the resistance sensors, the electrical connection element, the line connections, the double contacts and the equipotential surface, represent the measuring arrangement for flow measurement, i.e. a flow sensor.

In an optional embodiment, such a flow sensor can be supplemented with a pairing or combination of the test contact element and the test contact on the sensor side.

In advantageous embodiments of the embodiments described, the double contacts can be used in such a way that the operating current from the measuring bridge is conducted via the cable connections and the electrical connection element to the respective resistance sensor on the support elements through one contact of the double contacts and the electrical resistance measurement is carried out through the other contact of the double contacts.

A measuring technique of this type is also referred to as a four-wire measuring arrangement with four wires (Drive_1, Drive_2, Sense_1, Sense_2). In the four-wire measuring arrangement, a known electrical measuring current flows through the resistance to be measured via two current-supplying wires (Drive_1, Drive_2). The voltage dropping across this resistor is measured at high impedance via two further lines (Sense_1, Sens_2). The result is the advantage that voltage drops caused by line resistances of the current-supplying lines (Drive_1, Drive_2) do not falsify the measured resistance value of the resistor to be measured.

The control unit can also be configured to measure other voltage signals from the measuring bridge in addition to the resistance measurement of the resistance sensors and the measurement voltages at the precision measuring resistors. This includes, for example, the supply voltage and/or the bridge supply voltage of the measuring bridge.

Details on voltages of the measuring bridge such as measuring voltages at precision resistors, supply voltage or bridge supply voltage can be found in FIG. 4 in the context of the associated reference numbers and designations in the reference number list, and the description of the figures.

In a particularly preferred embodiment of the measuring arrangement, a comparison data set can be stored in a data storage element. The data storage element can be configured as an addition to or as a part of the sensor-side test contact or can be coupled to (operatively connected to) the sensor-side test contact or the carrier element.

Such a data storage element can, for example, be configured as an EProm, EEProm or an RFID tag and can be used to store a data record.

For example, data such as a manufacturing date of the flow sensor, an expiration date of the flow sensor, characteristic data or at least one characteristic curve of the flow sensor can be stored or saved in the data set. The data set can also be configured as a comparison data set, which can be used by the control unit for a comparison with current data determined during operation of the flow sensor or other data.

In a particularly preferred embodiment of the measuring arrangement, the control unit can be configured to carry out a comparison with values from a comparison data set using the data set of current sensor-specific values. Such a comparison can be used—in particular with the addition of characteristic data or characteristic curves—on the one hand for a possible correction of measured flow values, and on the other hand to determine the status of the flow sensor or to determine whether the flow sensor is ready for operation. The comparison data set can include the following data, for example:
sensor-specific data that can be determined during a check as part of a zero adjustment of the flow sensor;
sensor-specific data that can be determined during a check as part of the production of the flow sensor;
sensor-specific historical data that could be determined during a measurement operation of the flow sensor;
typical operating data for the flow sensor or the measuring bridge (400) in measuring mode.

In a particularly preferred embodiment of the measuring arrangement, the sensor-specific or typical operating data can include the following parameters:
cold resistance measured values of the resistance sensors C1, W2, W1;
hot resistance measured values of the resistance sensors C1, W2, W1;
voltage signals from the measuring bridge, which indicate a current flow through one of the resistance sensors;
voltage signals from the measuring bridge, which indicate a current flow through a precision measuring resistor;
voltage signals of the measuring bridge, which indicate an operating state of the measuring bridge.

The voltage signals include, for example, a supply voltage of the energy supply (U+) and/or a bridge supply voltage as well as measuring voltages at the precision measuring resistors of the measuring bridge.

For the purposes of the present invention, cold resistances are to be understood as measured resistance values of the resistance sensors, i.e. in particular of the platinum resistance wires, which were determined during energization with a measuring current that causes a temperature level of the resistance sensors, which is essentially identical to the ambient temperature in a range of approximately 20° C. to 30° C. or up to approximately 10° C. above the ambient temperature.

For the purposes of the present invention, hot resistances are to be understood as measured resistance values of the resistance sensors which were determined during energization with a measuring current which causes a temperature level of the resistance sensors in a range of approximately 50° C. to 150° C. above the ambient temperature.

For details with regard to voltages of the measuring bridge, measuring voltages at precision resistors, supply voltage, bridge supply voltage and other aspects of the measuring bridge in detail, reference is also made at this point in the description to FIG. 4 in the context of the list of reference numbers and the descriptions of the figures.

In a particularly preferred embodiment of the measuring arrangement, the control unit can be configured to determine an indicator on the basis of the comparison which indicates that the flow sensor is ready for operation and provides an output signal which indicates that it is ready for operation. The output signal provided can provide both a user and a higher-level system of the measuring arrangement, such as a ventilation system or an anesthesia system, a data network, with information on whether the measuring arrangement and/or the flow sensor is ready for operation in principle or not and/or information on the measuring accuracy of the flow sensor in current operation or to be expected in subsequent operation.

The present invention will now be explained in more detail with the aid of the following figures and the associated description, without limiting the general concept of the invention. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing an electrical plug connection;

FIG. 2 is a schematic view showing the electrical plug connection with a measuring bridge;

FIG. 3 is a schematic view showing a variant of the electrical plug connection shown in FIG. 1; and

FIG. 4 is a diagram showing a flow sensor integrated into a measuring bridge.

### DESCRIPTION OF PREFERRED EMBODIMENTS

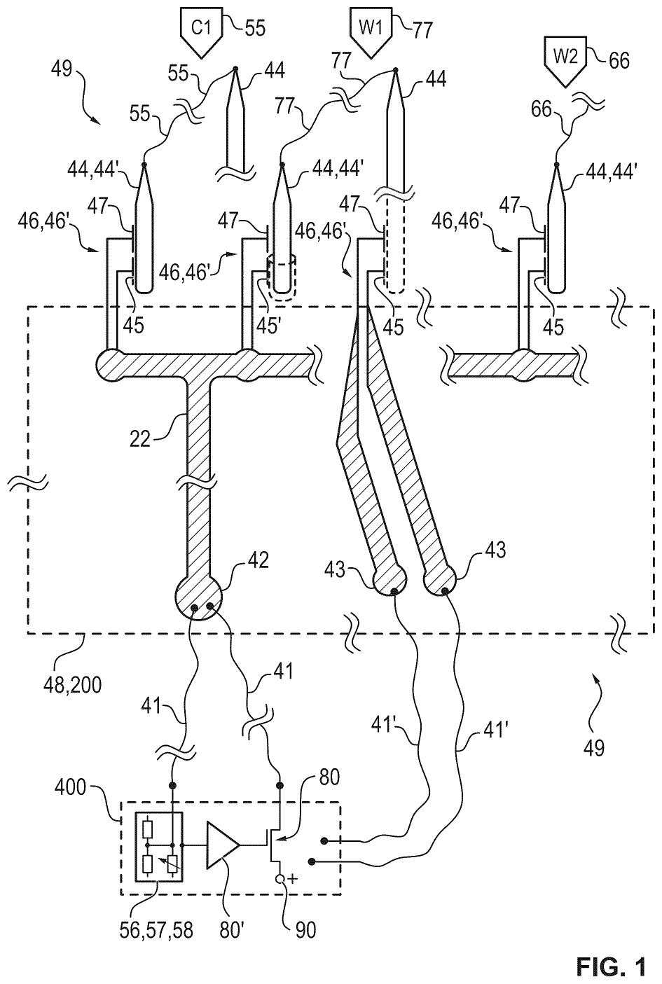

Referring to the drawings, FIG. 1 shows a schematic representation of an electrical plug connection 49 with redundant contacts 45, 46, 47 for a flow sensor. Shown are resistance sensors C1 55, W2 66, W1 77 configured as platinum wires and clamped onto support elements 44 and soldered or welded on, with contacts 46 adapted to the support elements 44 with two double contact elements 45, 47. If, in an exemplary embodiment, the support elements 44 are configured as round rods or pins 44′, the contacts 46 are configured as round sockets 46′. A respective socket 45′ may be provided for all contacts 46, 46′ of FIG. 1 and is shown by way of example only on the resistance sensor W1 77 for reasons of clarity of the drawing.

Each of the support elements 44 is contacted by the two double contact elements 45, 47, so a double contact is formed and each of the resistance sensors C1 55, W2 66, W1 77—i.e. each of the platinum wires—is electrically conductively connected to a common connecting element 48 by means of four contacts.

From the common connecting element 48, the resistance sensors C1 55, W2 66, W1 77 are electrically connected by means of contact points 42, 43 and electrical line connections 41, 41′ to a measuring bridge 400, which is only indicated in FIG. 1 by some electronic components 56, 57, 58, 80, 80′, 90.

The contact points 42 lead the double contact elements 45, 47 in each case—shown in this FIG. 1 as an example for a support element 44 of the resistance sensor C1 55—electrically together via an equipotential surface 22 arranged in the common connecting element 48 via the line connections 41 to the measuring bridge 400.

The contact points (contacts) 43 lead the double contact elements 45, 47—shown in this FIG. 1 as an example for a support element 44 of the resistance sensor W2 77—separately in the common connecting element 48 via the cable connections 41′ to the measuring bridge 400.

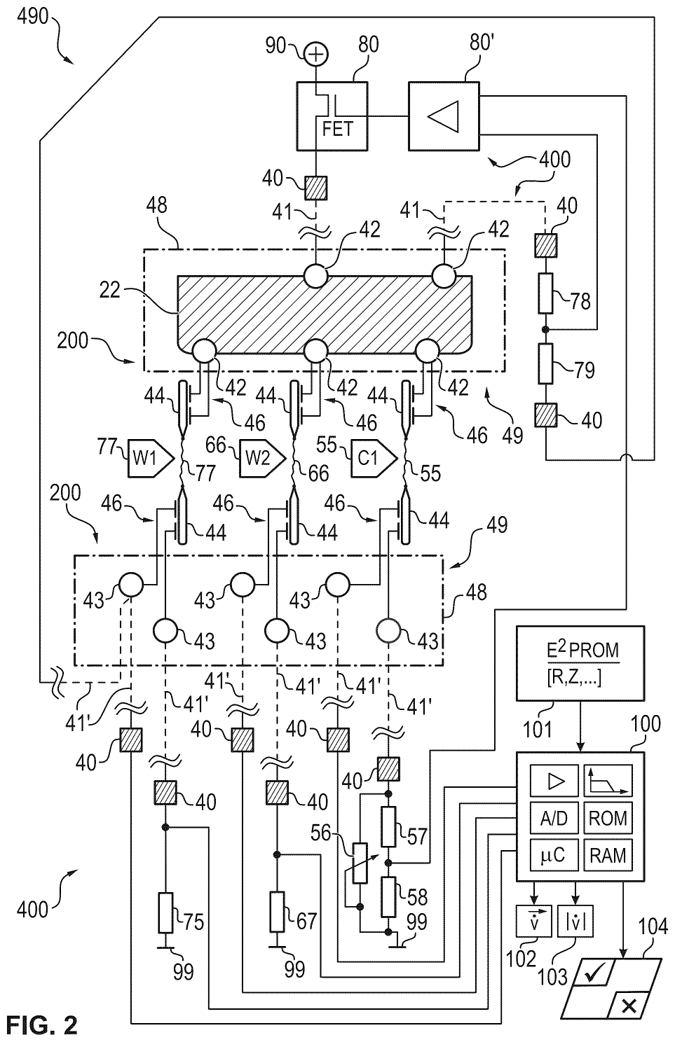

Further illustrations and explanations of the electrical plug connection 49 with the equipotential surface 22 are shown in FIG. 2.

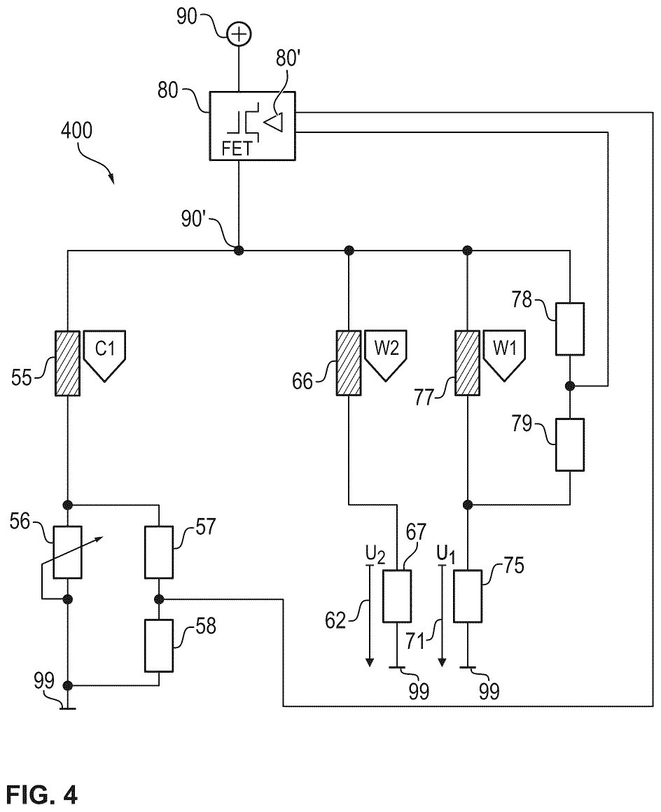

Further illustrations and explanations of the measuring bridge 400 in detail are shown in FIG. 2 and in particular in FIG. 4.

FIG. 2 shows a schematic representation of the electrical connection element 48 according to FIG. 1 with an equipotential surface 22 as part of an electrical plug connection 49 for a flow sensor for contacting the resistance sensors C1 55, W2 66, W1 77 according to FIG. 1 with a measuring bridge 400. The measuring bridge 400, the electrical plug connection 49 and the resistance sensors C1 55, W2 66, W1 77 together form a measuring arrangement 490 for a flow measurement. Identical elements in FIGS. 1 and 2 are labeled with the same reference numbers in FIG. 1 and FIG. 2.

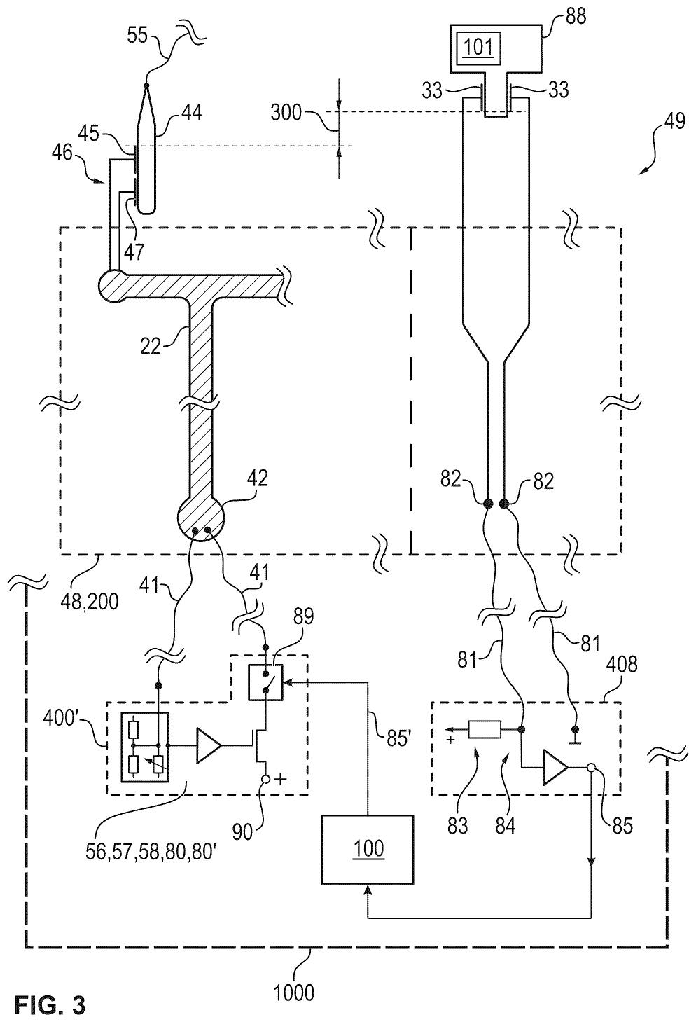

The electrical connection element 48 forms one side of a connecting cable with line connections 41, 41′ and 81 (FIG. 3) and enables the sensor-side contacting of three resistance sensors C1 55, W2 66, W1 77 of a flow sensor.

The other side of the connecting cable is connected to a measuring bridge 400 with a control unit 100 and electronic components 56, 57, 58, 67, 75, 78, 79, 80, 80′ via cable connections 41, 41′ and 81 (FIG. 3) with a voltage supply (+U) 90 and with earth potential (0V) 99.

In addition, electrical connection points for further contacting the resistance sensors of the flow sensor and, by way of example, some electronic components of the measuring bridge 400 such as resistors, resistor networks, amplifier circuits (OP amps), field effect transistors (FET) are indicated in a schematic manner, which are intended to illustrate how the electrical contacts and connections with the resistance sensors C1 55, W2 66, W1 77 and a measuring bridge 400, 408 (FIG. 3) can interact to function as a flow sensor by way of example.

The principle function as a flow sensor with a measuring bridge 400 is illustrated by FIG. 4, so that the description of this FIG. 2 focuses on explanations of the interaction of the contacting of the resistance sensors C1 55, W2 66, W1 77 through electrical contact points 42, 43 and through the equipotential surface 22 with the measuring bridge 400

Electrical contacts are shown for the redundant contacting of three resistance sensors C1 55, W2 66, W1 77, as shown and explained in more detail in FIG. 1. Each of the three resistance sensors C1 55, W2 66, W1 77 is electrically conductively attached to two measuring supports 44.

Three measuring supports of the total of six measuring supports 44 are each contacted separately via the contact points 43 with double contact elements 45, 47, preferably configured as sockets, and are each connected separately to the measuring bridge 400 via individual line connections 41′.

Three measuring supports of the total of six measuring supports 44 are each contacted with the equipotential surface 22 using double contact elements 45, 47, preferably configured as sockets, and are centrally connected, so that all three resistance sensors C1 55, W2 66, W1 77 each have an identical voltage potential on one side.

The contact points 42 electrically connect the double contact elements 45, 47 via the equipotential surface 22 and via the cable connections 41 to the measuring bridge 400.

The voltage drops at the resistors 75, 67 in the measuring bridge 400 are provided to the control unit 100 as voltage signals U1 71, U2 62 and evaluated by the control unit 100 for a qualitative determination 103 of the flow rate and a direction detection 102 of the flow rate. The control unit 100 can also be configured to include data and/or information in the context of the flow sensor, such as parameters or properties 101 (properties saved at a data storage element 101), of the three resistance sensors C1 55, W2 66, W1 77. This is used for the evaluation and thus to determine an operating state 104 and/or error states of the flow sensor with the resistance sensors C1 55, W2 66, W1 77, measuring bridge 400, line connections 41, 41′, 81 (FIG. 3), contact points 40, 42, 43, 82 (FIG. 3), contact arrangements 46 with the double contact elements 45, 47 in conjunction with the support elements 44.

Examples of the properties of the three resistance sensors C1 55, W2 66, W1 77 are resistance values such as platinum hot resistors, platinum cold resistors, characteristic curves or interpolation points of characteristic curves of the resistance sensors C1 55, W2 66, W1 77 or also typical voltage signals 62, 71 of the measuring bridge 400

The data and/or information in the context of the flow sensor, such as properties of the three resistance sensors C1 55, W2 66, W1 77, can be stored in a data memory 101 which, for example, can be arranged as an EEProm on the flow sensor and is configured to provide data and/or information as a data set Z by means of the electrical plug connection 49 and contact points 82 (FIG. 3) in an extended measuring bridge 408 (FIG. 3) of the control unit 100.

The common connecting element 48 with the double contact elements 45, 46, the equipotential surface 22 and the contact points 42, 43 can be formed by means of a carrier element 200, for example in the form of a printed circuit board (PCB), which can be arranged in the electrical plug connection 49. The electrical plug connection 49 can preferably be configured as an electrical connection element with a multi-pole housing, in which the carrier element 200 is also arranged.

FIG. 3 shows a schematic representation of a variant of the electrical plug connection 49 according to FIG. 1 for a flow sensor with a test contact element 33 and a test contact 88 on the sensor side with the measuring bridge 400 according to FIG. 2 and with an extended measuring bridge 408. Identical elements in FIGS. 1, 2 and 3 are designated with the same reference numbers in FIGS. 1, 2 and FIG. 3.

FIG. 3 shows schematically how, when the support elements 44 of the resistance measuring sensors C1 55, W2 66, W1 77 are connected to the double contact elements 45, 47, after electrical contact is made between the support elements 44 and the double contact elements 45, 47, an electrical contact between the sensor-side test contact 88 and the test contact element 33 is subsequently or successively closed. The lagging contact connection is based on a distance difference 300 between the contact of the sensor-side test contacts 45, 47 of the contact arrangement with the support elements 44 compared with the contact between the sensor-side test contact 88 and the test contact element 33. The contact closure between the sensor-side test contact 88 and the test contact element 33 by means of contact points 82 and connecting lines 81 can be evaluated by means of the extended measuring bridge 403 with the aid of a comparator circuit with electronic components 83, 84 and provided as a status signal 85 to the control unit 100.

The control unit 100 can convert the status signal 85 into a switching signal 85′ and activate a switching element 89 with the switching signal 85′ in order to switch through and release the supply voltage 90 of the measuring bridge 400 to the resistance sensors C1 55, W2 66, W1 77 and thus start the operation of the flow sensor. This results in the advantageous situation that electrical energy is only connected to the resistance sensors C1 55, W2 66, W1 77 when all contact points 42, 43 of the common connecting element 48 of the electrical plug connection 49 are actually securely and successfully electrically connected to the measuring bridge 400. This can effectively prevent possible contact problems occurring during the electrical connection between the measuring bridge and the common connecting element 48 and possible malfunctions or damage to the resistance sensors C1 55, W2 66, W1 77 resulting therefrom.

FIG. 4 shows an example and schematic of a flow sensor integrated into a measuring bridge 400 in a basic function. The flow sensor is shown with three resistance sensors C1 55, W2 66, W1 77 in a configuration with electronic components without a representation of a measuring cuvette as a flow chamber and without explicit representation of the electrical plug connections according to FIGS. 1, 2, 3. Identical elements in FIGS. 1, 2, 3 and 4 are designated with the same reference numbers in FIGS. 1, 2, 3 and FIG. 4. This configuration shown can in principle be used for sensor operation in a constant temperature anemometry (CTA) operating mode.

Shown are three resistance sensors C1 55, W2 66, W1 77, which are configured as platinum wires, clamped onto support elements 44 (FIG. 1) and soldered or welded on. The three resistance sensors C1 55, W2 66, W1 77 are arranged together in a measuring cuvette, through which the flow can pass in two directions.

The resistance sensor C1 55 is used in sensor operation as a resistance sensor to compensate for the temperature of a sample gas flowing in the measuring cuvette of the flow sensor.

The resistance sensor W1 77 is used in sensor operation of the measuring bridge 400 to detect a flow rate of the sample gas flowing in the measuring cell of the flow sensor. The resistance sensor W2 66 is used in sensor mode to detect a flow direction of the flow rate of sample gas flowing in the measuring cell of the flow sensor.

The electronic components with balancing resistor (adjustment resistor) 56, further resistors 67, 75, resistor networks 57, 58, 78, 79, a circuit (OP-AMP) 80′ for forming a control difference and an active setting and switching element (FET) 80 make it possible to control a supply 90 of the measuring bridge 400 in such a way that a temperature with a constant difference above the temperature of the sample gas flowing through the measuring cuvette is given at the resistance sensor W1 77.

The balancing resistor 56 is used to adjust the circuit components 57, 58, 67, 75, 78, 79, 80, 90 with the resistance sensors C1 55, W2 66, W1 77 to a defined operating point without a current at the resistance sensors C1 55, W2 66, W1 77.

In an alternative embodiment, the balancing resistor 56 can be configured as a balancing element, for example as an analog or digital resistance potentiometer or as an arrangement with a digital/analog converter, which enables automated balancing, for example by a control unit 100 (FIG. 2) using a microcontroller (μC).

The resistors 67, 75 are preferably configured as precision measuring resistors, since the voltage signals U1 71, U2 62 at these resistors correspond to the electrical current changes flowing into the measuring bridge 400 when the flow changes, which represent a measure of changes or increases in the flow rate at the resistance measuring sensors W2 66, W1 77.

A qualitative determination 102 (FIG. 2) of the flow rate can be carried out by a control unit 100 (FIG. 2) by means of an evaluation of the voltage signals U1 71, U2 62.

A direction detection 102 (FIG. 2) of the flow rate can be carried out by a control unit 100 (FIG. 2) by means of a comparison of the voltage signals U1 71, U2 62. These voltage signals U1 71, U2 62 reflect if there is a heat transfer from the resistance sensor W2 66 to the resistance sensor W1 77 or if there is a heat transfer from the resistance sensor W1 77 to the resistance sensor W2 66 in a flow state due to the flow rate by means of flow.

In this way, in addition to a quantity 103 (FIG. 2) of the flow rate, a flow direction 102 (FIG. 2) of the flow rate can be detected in the flow sensor.

While specific embodiments of the invention have been shown and described in detail to illustrate the application of the principles of the invention, it will be understood that the invention may be embodied otherwise without departing from such principles.

### LIST OF REFERENCE NUMBERS

22 Equipotential surface (equipotential conductor body/equipotential area)
33 Monitoring contact
41, 41′ Cable (line) connections
42, 43 Contact points (contacts)
44 Support elements, pins
Double contact elements, elements of double sockets
46 Contact arrangement, socket-pin arrangements
47 Double contact elements, elements of double sockets
48 Common connecting element (common connector)
49 Electrical connection element (connector), electrical plug connection
55 Resistance sensor C1
56 Balancing resistor, balancing element
57, 58 Resistor network, resistors
62 Measuring voltage U2
66 Resistance sensor W2
67 Resistance, precision measuring resistor
71 Measuring voltage U1
75 Resistance, precision measuring resistor
77 Resistance sensor W1
78, 79 Resistor network, resistors
80, 80′ Active control and switching element (FET), (OP-Amp)
81 Cable (line) connections
82 Contact points (contacts)
83, 84 Electronic components, resistors
85 Status signal
85′ Switching signal
88 Sensor-side test contact
89 Switching element
90 Supply voltage, energy feed, voltage source, U+
90′ Bridge supply voltage
99 Ground potential, 0V
100 Control unit
101 Data memory, EProm, EEProm, RFID
102 Flow direction of the flow rate
103 Value of the flow rate
104 Indicator for an operating status or error status
200 Carrier element, circuit board
300 Distance difference: sensor-side test contact <-> support elements
400 Measuring bridge
408 Extended measuring bridge

What is claimed is:

1. A measuring arrangement comprising:
a measuring bridge; and
an electrical connection element for a flow sensor, the electrical connection element being configured to form a plurality of electrical plug connections between the measuring bridge and a plurality of supporting elements of at least two resistance sensors of the flow sensor, the flow sensor being configured for hot-wire anemometry flow rate measurement, the electrical connection element comprising a plurality of electrical contact arrangements arranged on a carrier element, the plurality of electrical contact arrangements comprising at least four electrical contact arrangements, wherein the carrier element comprises at least one common equipotential surface which electrically conductively connects at least two contact arrangements, of the plurality of electrical contact arrangements, to one another.

2. A measuring arrangement according to claim 1, wherein the electrical contact arrangements are each configured with a two contact arrangement as double contact elements and are arranged on the carrier element, wherein each of the double contact elements is configured to receive the same support element of the corresponding resistance measuring sensor.

3. A measuring arrangement according to claim 2, wherein the double contact elements are configured in cooperation with the carrier element to connect to line connections of a connecting cable and wherein the connecting cable is configured with the line connections to electrically contact with the measuring bridge.

4. A measuring arrangement according to claim 2, further comprising an electrical test contact element, which is arranged on the electrical connection element or on the carrier element to form an electrical connection between the measuring bridge or another measuring bridge and a sensor-side test contact on the carrier element, wherein the electrical test contact element is configured in relation to the sensor-side test contact and the support elements such that with the flow sensor connected to the electrical connection element, an electrically lagging connection is formed, between the sensor-side test contact and the electrical test contact element, which electrically lagging connection is lagging with respect to the electrical connection between all the double contact elements and the associated support elements.

5. A measuring arrangement according to claim 4, further comprising a control unit configured to initiate activation of an electrical power supply or electrical voltage supply of the measuring bridge when the flow sensor is connected to the electrical connection element upon a contact closure between the sensor-side test contact and the electrical test contact element.

6. A measuring arrangement according to claim 5, wherein the control unit is configured to initiate or perform an electrical resistance measurement on at least one of the resistance sensors of the flow sensor and to determine and provide a data set of current sensor-specific values therefrom.

7. A measuring arrangement according to claim 6, further comprising a data storage element, wherein a comparison data set is stored in the data storage element, wherein the data storage element is operatively connected to the sensor-side test contact or to the carrier element.

8. A measuring arrangement according to claim 7, wherein the control unit is configured to carry out a comparison between values of a comparison data set and the data set of current sensor-specific values, wherein the comparison data set comprises:
sensor-specific data, which can be determined during a check as part of a zero adjustment of the flow sensor; and/or
sensor-specific data that can be determined during a check as part of a production of the flow sensor; and/or
sensor-specific historical data that is determined during a measurement operation of the flow sensor; and/or
operating data, in measuring mode, for the flow sensor or the measuring bridge.

9. A measuring arrangement according to claim 8, wherein the sensor-specific data or operational data comprises:
cold resistance measured values of the resistance sensors; or
hot resistance measured values of the resistance sensors; or
voltage signals of the measuring bridge, which indicate a current flow through one of the resistance sensors; or
voltage signals from the measuring bridge, which indicate a current flow through a precision measuring resistor; or
voltage signals of the measuring bridge, which indicate an operating state of the measuring bridge.

10. A measuring arrangement according to claim 8, wherein the control unit is configured to determine, based on the comparison, an indicator that the flow sensor is ready for operation, and to provide an output signal which indicates that the flow sensor is ready for operation.

11. A measuring arrangement comprising:
a measuring bridge; and
an electrical connection element for a flow sensor, the electrical connection element being configured to form electrical plug connections between the measuring bridge and at least six support elements of three resistance sensors of the flow sensor, the flow sensor being configured for hot-wire anemometry flow rate measurement, the electrical connection element comprising a plurality of electrical contact arrangements arranged on a carrier element, the plurality of electrical contact arrangements comprising at least six electrical contact arrangements, wherein the carrier element comprises at least one common equipotential surface which electrically conductively connects at least three contact arrangements, of the plurality of contact arrangements, to one another.

12. A measuring arrangement according to claim 11, wherein the electrical contact arrangements are each configured with a two contact arrangement as double contact elements and are arranged on the carrier element, wherein each of the double contact elements is configured to receive the same support element of the corresponding resistance measuring sensor.

13. A measuring arrangement according to claim 12, wherein the double contact elements are configured in cooperation with the carrier element to connect to line connections of a connecting cable and wherein the connecting cable is configured with the line connections to electrically contact with the measuring bridge.

14. A measuring arrangement according to claim 12, further comprising an electrical test contact element, which is arranged on the electrical connection element or on the carrier element to form an electrical connection between the measuring bridge or another measuring bridge and a sensor-side test contact on the carrier element, wherein the electrical test contact element is configured in relation to the sensor-side test contact and the support elements such that with the flow sensor connected to the electrical connection element, an electrically lagging connection is formed, between the sensor-side test contact and the electrical test contact element, which electrically lagging connection is lagging with respect to the electrical connection between all the double contact elements and the associated support elements.

15. A measuring arrangement according to claim 14, further comprising a control unit configured to initiate activation of an electrical power supply or electrical voltage supply of the measuring bridge when the flow sensor is connected to the electrical connection element upon a contact closure between the sensor-side test contact and the electrical test contact element.

16. A measuring arrangement according to claim 15, wherein the control unit is configured to initiate or perform an electrical resistance measurement on at least one of the resistance sensors of the flow sensor and to determine and provide a data set of current sensor-specific values therefrom.

17. A measuring arrangement according to claim 16, further comprising a data storage element, wherein a comparison data set is stored in the data storage element, wherein the data storage element is operatively connected to the sensor-side test contact or to the carrier element.

18. A measuring arrangement according to claim 17, wherein the control unit is configured to carry out a comparison between values of a comparison data set and the data set of current sensor-specific values, wherein the comparison data set comprises:
sensor-specific data, which can be determined during a check as part of a zero adjustment of the flow sensor; and/or
sensor-specific data that can be determined during a check as part of a production of the flow sensor; and/or
sensor-specific historical data that is determined during a measurement operation of the flow sensor; and/or
operating data, in measuring mode, for the flow sensor or the measuring bridge.

19. A measuring arrangement according to claim 18, wherein the sensor-specific data or operational data comprises:
cold resistance measured values of the resistance sensors; or
hot resistance measured values of the resistance sensors; or
voltage signals of the measuring bridge, which indicate a current flow through one of the resistance sensors; or
voltage signals from the measuring bridge, which indicate a current flow through a precision measuring resistor; or
voltage signals of the measuring bridge), which indicate an operating state of the measuring bridge.

20. A measuring arrangement according to claim 18, wherein the control unit is configured to determine, based on the comparison, an indicator that the flow sensor is ready for operation, and to provide an output signal which indicates that the flow sensor is ready for operation.
